(19) United States
(12) Patent Application Publication
(10) Pub. No.: US 2006/0002699 A1
(43) Pub. Date: Jan. 5, 2006

(54) Camera

(75) Inventors: Po-Chih Chen, Taipei City (TW); Jih-Yung Lu, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/141,022

(22) Filed: Jun. 1, 2005

(30) Foreign Application Priority Data
Jun. 30, 2004 (TW) 93119449

(51) Int. Cl. G03B 3/00

(52) U.S. Cl. 396/144

(57) ABSTRACT

A camera. A first adjusting element between a lens holder and a base contacts the lens holder and a second adjusting element between the lens holder and the base contacts the base. The first adjusting element is movably received in the second adjusting element and adjusts distance between the lens holder and the base.

### BACKGROUND

The present invention relates to a camera with a focus adjustment mechanism.

In general, camera lens modules include an optical lens set, a shutter, a diaphragm, focus adjustment mechanism and focus mode switch. To reduce the size of the camera, corresponding element size must be reduced.

FIG. 1 is an exploded perspective view of a focus adjustment mechanism of a conventional camera. A lens 80 is supported by a lens holder 100′. A focus mode switch 40 and a focus element 60 are disposed between the lens holder 100′ and a base (a charge coupled device holder in a digital camera) 200′. The focus mode switch 40 switches the lens 80 between general focus mode and macro focus mode. The focus element 60 is normally used only during fabrication and assembly. Focus is adjusted by engaging adjusting teeth 61 on the periphery of the focus element 60 to rotate the focus element 60. When focus is adjusted, the focus element 60 is fixed permanently.

In FIG. 1, the focus mode switch 40 and the focus element 60 overlap. Since the focus element 60 is not used after the camera leaves the factory, a compact structure is preferred. In conventional structure, however, the focus mode switch 40 and the focus element 60 occupy considerable space.

### SUMMARY

A camera according to an embodiment of the invention comprises a lens holder, a base, a first adjusting element between the lens holder and the base contacting the lens holder, and a second adjusting element between the lens holder and the base contacting the base, wherein the first adjusting element is movably received in the second adjusting element to adjust distance between the lens holder and the base.

First and second adjusting elements are concentrically disposed with the first adjusting element rotatable with respect to the second adjusting element. The second adjusting element comprises a circular main body and a flange axially protruding therefrom to form a shoulder to receive the first adjusting element. The second adjusting element further comprises a plurality of teeth on the periphery of the flange for focus adjustment.

The flange is annular and includes a notch provided with a first edge and a second edge. The first adjusting element comprises a lever projecting from the periphery of the first adjusting element and through the notch is movable between the first and second edges when the first adjusting element is received in the second adjusting element.

The camera further comprises a guiding element connecting the lens holder and the base along which the lens holder moves toward or away from the base with the first adjusting element moving in the second adjusting element.

### BRIEF DESCRIPTION OF THE DRAWINGS

The present invention can be more fully understood by reading the subsequent detailed description and examples with references made to the accompanying drawings, wherein:

FIG. 1 is a perspective view of a conventional digital camera;

FIG. 2a is an exploded perspective view of a camera of an embodiment of the invention;

FIG. 2b is a partially exploded perspective view of a camera of an embodiment of the invention;

FIG. 3 is a perspective view of a camera of an embodiment of the invention; and

FIG. 4 is an assembled side view of a camera of an embodiment of the invention showing a lens holder, a focus mode switch and a focus element.

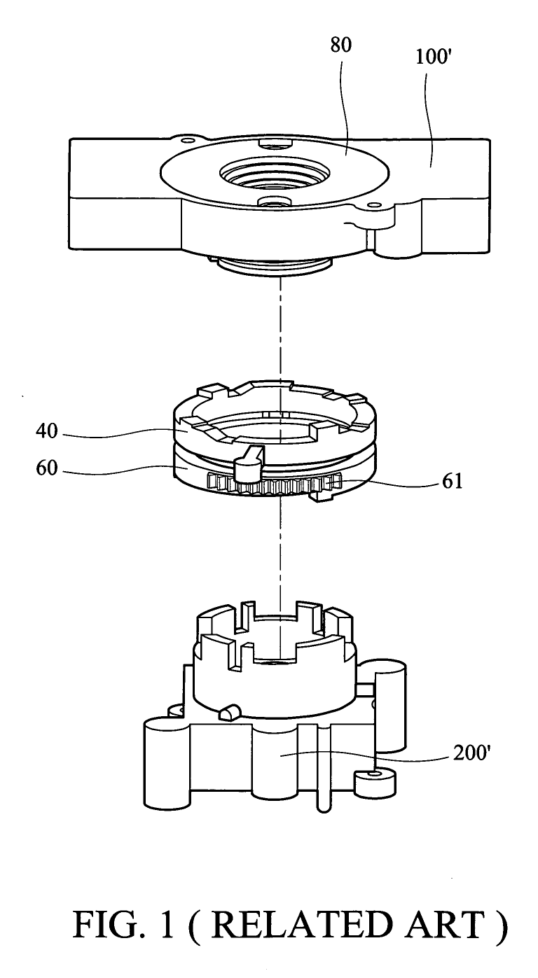

### DETAILED DESCRIPTION

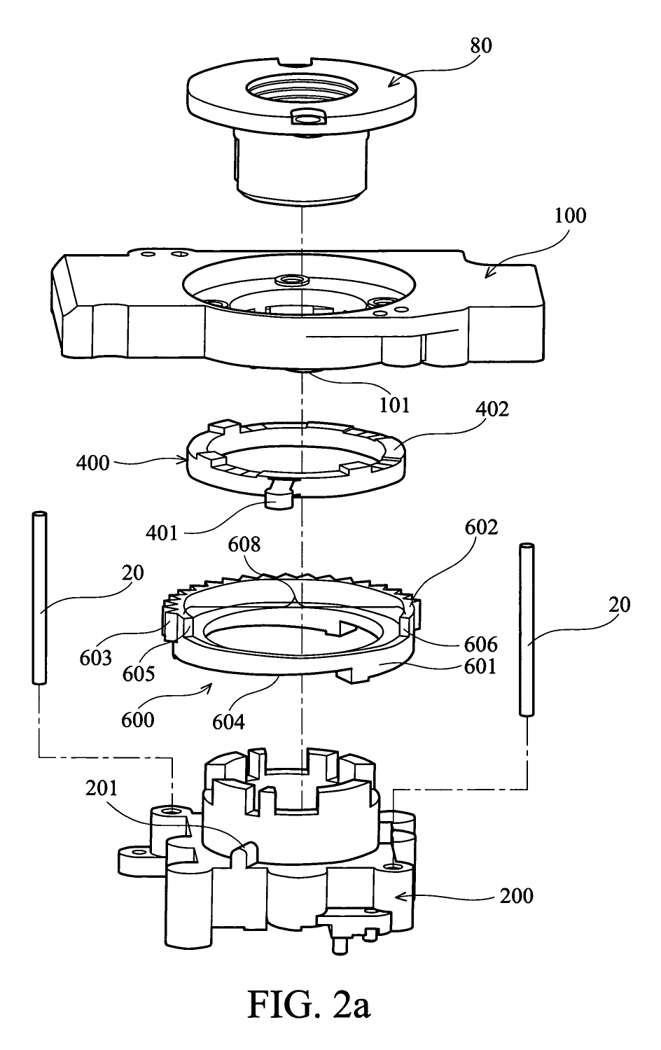

Referring to FIG. 2a, a camera comprises a lens 80, a lens holder 100 supporting the lens 80, a base 200 carrying a charge coupled device, a focus mode switch (a second adjusting element) 400 contacting the lens holder 100, and a focus element (a first adjusting element) 600 receiving the focus mode switch 400 and contacting the base 200.

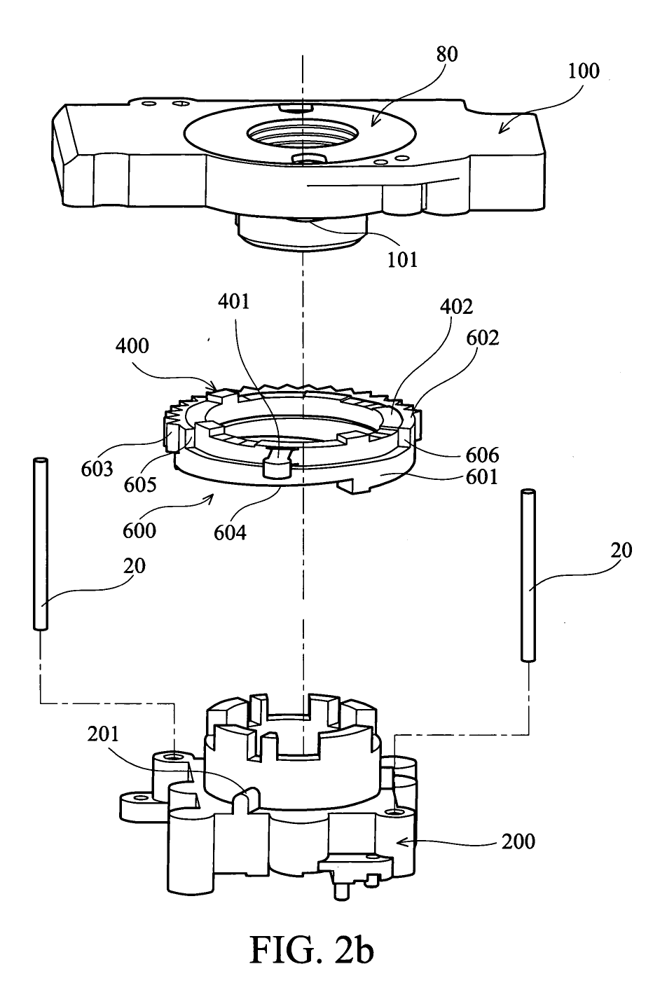

Referring to FIGS. 2a, 2b and 3, a guide bar (guiding element) 20 connects the lens holder 100 and the base serving as a charge coupled device holder (in a digital camera) 200. The lens holder 100 moves toward or away from the base 200 by rotation of the focus mode switch 400 and the focus element 600. The focus mode switch 400 and the focus element 600 are disposed between the lens holder 100 and the base 200. The focus element 600 includes an annular main body 601 and a flange 602 axially protruding from the main body 601. The focusing switch 400 is also annular and received in the focus element 600 (disposed on the main body 601 and encircled by the flange 602). The concentric configuration renders the focus mode switch 400 rotatable within the focus element 600.

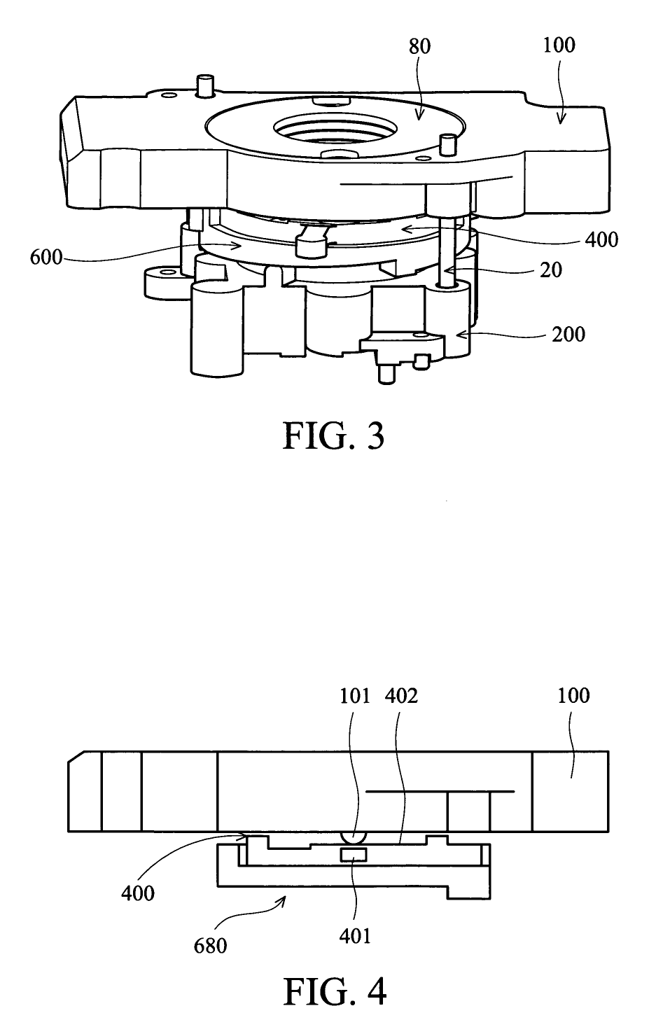

In FIG. 2b, the annular flange 602 is provided with a notch 608 having a first edge 605 and a second edge 606. The focus mode switch 400 is provided with a finger 401 which extends through the notch 608, movable between the first and second edges 605 and 606 when the focus mode switch 400 is received in the focus element 600. The finger 401, when pushed, rotates the focus mode switch 400. A plurality of first portions 402 of various heights abuts a protrusion 101 on the lens holder 100, as shown in FIG. 4. The lens holder 100 can move toward or away from the base 200 along the guide bar 20 by rotation of the focus mode switch 400, thereby adjusting distance between the lens 80 and the charge coupled device (not shown).

The focus element 600 has adjusting teeth 603, engagement of which provides adjustment of focus. The focus element 600 has a plurality of inclined second portions 604 abutting a protrusion 201 on the base 200. The focus element 600, when rotated, moves the lens holder 100 toward or away from the base 200 along the guide bar 20 to provide focus adjustment.

The concentric structure of the focus mode switch and the focus element of the embodiment occupies less space than in the conventional structure.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A camera, comprising:
a lens holder;
a base;
a first adjusting element disposed between the lens holder and the base, and contacting the lens holder; and
a second adjusting element disposed between the lens holder and the base, and contacting the base;
wherein the first adjusting element is movably received in the second adjusting element providing adjustment of the distance between the lens holder and the base.

2. The camera as claimed in claim 1, wherein the first and second adjusting elements are concentrically disposed, with the first adjusting element rotatable with respect to the second adjusting element.

3. The camera as claimed in claim 2, wherein the second adjusting element comprises a circular main body and a flange axially protruding therefrom to receive the first adjusting element.

4. The camera as claimed in claim 3, wherein the second adjusting element further comprises a plurality of teeth on the periphery of the flange to provide focus adjustment.

5. The camera as claimed in claim 3, wherein the flange is partially annular and comprises a notch comprising a first edge and a second edge.

6. The camera as claimed in claim 5, wherein the first adjusting element comprises a lever projecting from the periphery of the first adjusting element, extending through the notch, to be movable between the first and second edges when the first adjusting element is received in the second adjusting element.

7. The camera as claimed in claim 1 further comprising a guiding element connecting the lens holder and the base, along which the lens holder moves toward or away from the base when the first adjusting element moves in the second adjusting element.

8. The camera as claimed in claim 1, wherein the first adjusting element comprises a first surface facing the lens holder and a plurality of first portions of various heights on the first surface, contacting the lens holder, and the distance between the lens holder and the base is adjusted by rotation of the first adjusting element.

9. The camera as claimed in claim 1, wherein the second adjusting element comprises a second surface facing the base and a plurality of inclined second portions on the second surface contacting the base, and the distance between the lens holder and the base is adjusted by rotation of the second adjusting element.
